(19) United States
(12) Patent Application Publication
(10) Pub. No.: US 2025/0095888 A1
(43) Pub. Date: Mar. 20, 2025

(54) POSITIVE TEMPERATURE COEFFICIENT OVER-CURRENT PROTECTION DEVICE

(71) Applicant: FUZETEC TECHNOLOGY CO., LTD., New Taipei City (TW)

(72) Inventors: Jack Jih-Sang CHEN, New Taipei City (TW); Chang-Hung JIANG, New Taipei City (TW); Ching-Chiang YEH, New Taipei City (TW); Ming-Chun LEE, New Taipei City (TW)

(21) Appl. No.: 18/467,574

(22) Filed: Sep. 14, 2023

(51) Int. Cl. H01C 7/02; H01C 1/14; H02H 9/02

(52) U.S. Cl. CPC H01C 7/027; H01C 1/1406; H02H 9/026

(57) ABSTRACT

A PTC over-current protection device includes a first PTC component, a second PTC component, a first insulation layer, a first conductive via, and a second conductive via. The first PTC component includes a first electrode, a second electrode, and a first PTC element sandwiched between the first electrode and the second electrode. The second PTC component includes a third electrode, a fourth electrode, and a second PTC element sandwiched between the third electrode and the fourth electrode. The first insulation layer is disposed between the first PTC component and the second PTC component. The first conductive via electrically connects the first electrode and the third electrode, and the second conductive via electrically connects the second electrode and the fourth electrode.

### FIELD

The disclosure relates to a positive temperature coefficient (PTC) over-current protection device, and more particularly to a PTC over-current protection device that includes two PTC components, an insulation layer disposed between the two PTC components, and conductive vias.

### BACKGROUND

A positive temperature coefficient (PTC) device exhibits a PTC effect that renders the same to be useful as a circuit over-current protection device, such as a resettable fuse. The PTC device includes a PTC polymer element and two electrodes attached to two opposite surfaces of the PTC polymer element, respectively.

The PTC polymer element includes a polymer matrix that contains a crystalline region and a non-crystalline region, and a particulate conductive filler dispersed in the non-crystalline region of the polymer matrix and formed into a continuous conductive path for electrical conduction between the two electrodes. The PTC effect is a phenomenon that, when temperature of the polymer matrix is raised to its melting point, crystals in the crystalline region start to melt and a new non-crystalline region is generated. As the new non-crystalline region is increased to a certain extent and merges with the original non-crystalline region, the conductive path of the particulate conductive filler becomes discontinuous and resistance of the PTC polymer element increases rapidly, thereby resulting in electrical disconnection between the two electrodes.

FIG. 1 illustrates a conventional PTC over-current protection device that includes a PTC component 1, two electrodes 2, and two conductive leads 3. The conventional PTC over-current protection device still has room for improvement.

### SUMMARY

Therefore, an object of the disclosure is to provide a positive temperature coefficient (PTC) over-current protection device that can alleviate at least one of the drawbacks of the prior art.

According to the disclosure, the PTC over-current protection device includes a first PTC component, a second PTC component, a first insulation layer, a first conductive via, and a second conductive via.

The first PTC component includes a first electrode, a second electrode, and a first PTC element sandwiched between the first electrode and the second electrode. The second PTC component includes a third electrode, a fourth electrode, and a second PTC element sandwiched between the third electrode and the fourth electrode. The first insulation layer is disposed between the first PTC component and the second PTC component. The first conductive via electrically connects the first electrode and the third electrode, and the second conductive via electrically connects the second electrode and the fourth electrode.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a schematic view illustrating a conventional positive temperature coefficient (PTC) over-current protection device.

FIGS. 2-10B are schematic views illustrating various embodiments of a PTC over-current protection device according to the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

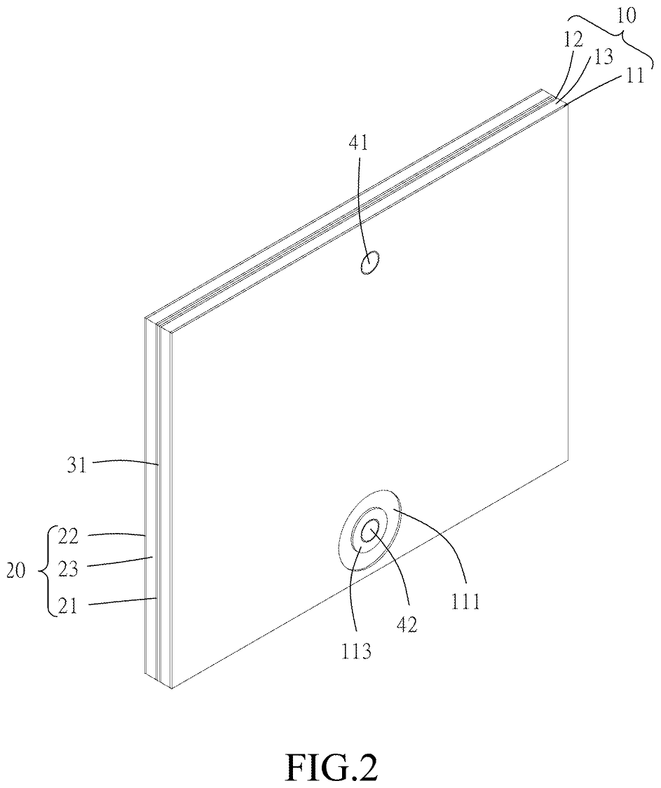

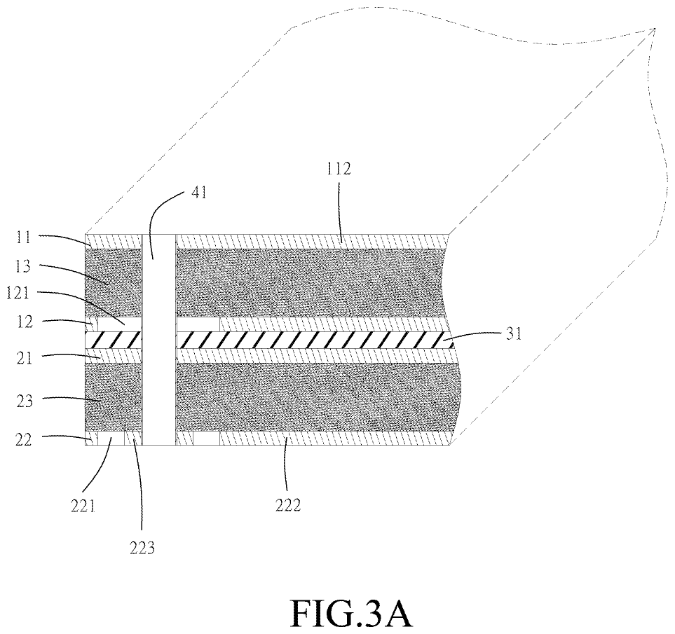

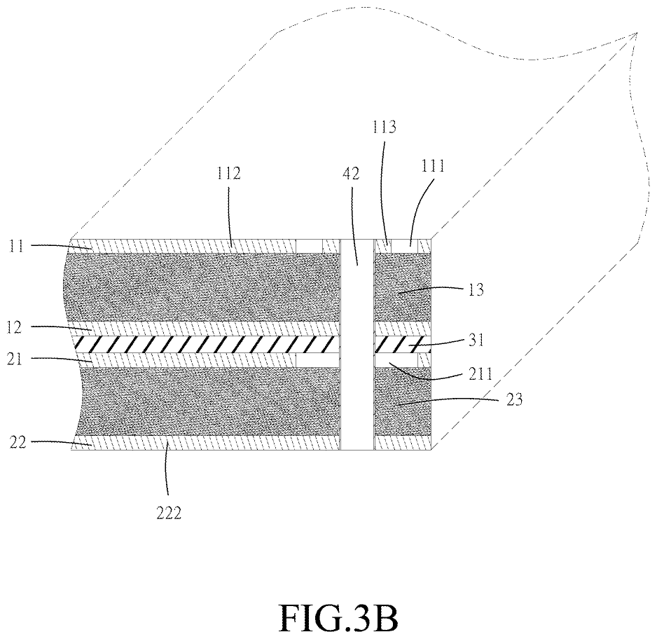

Referring to FIGS. 2 to 3B, an embodiment of a positive temperature coefficient (PTC) over-current protection device according to the disclosure includes a first PTC component 10, a second PTC component 20, a first insulation layer 31, a first conductive via 41, and a second conductive via 42.

The first PTC component 10 includes a first electrode 11, a second electrode 12, and a first PTC element 13 sandwiched between the first electrode 11 and the second electrode 12. The first PTC element 13 may be a polymeric PTC layer that includes a polymer matrix and a conductive filler dispersed in the polymer matrix. The polymer matrix is made from a polymer composition that contains a non-grafted olefin-based polymer. In certain embodiments, the non-grafted olefin-based polymer is high density polyethylene (HDPE). In other embodiments, the polymer composition further includes a carboxylic anhydride-grafted olefin-based polymer. Examples of the conductive filler may include, but are not limited to, carbon black, metal, electrically conductive ceramic, and combinations thereof. The first and second electrodes 11, 12 may each be a copper foil sheet such as a nickel-plated copper foil sheet.

The second PTC component 20 includes a third electrode 21, a fourth electrode 22, and a second PTC element 23 sandwiched between the third electrode 21 and the fourth electrode 22. The second PTC element 23 may be made of a material the same as that of the first PTC element 13. The third and fourth electrodes 21, 22 may also each be a copper foil sheet such as a nickel-plated copper foil sheet similar to the first and second electrodes 11, 12.

The first insulation layer 31 is disposed between the first PTC component 10 and the second PTC component 20. In this embodiment, the second electrode 12 and the third electrode 21 are disposed adjacent to the first insulation layer 31 relative to the first electrode 11 and the fourth electrode 22. The first insulation layer 31 may be made of epoxy glass fiber.

In this embodiment, the first conductive via 41 electrically connects the first electrode 11 and the third electrode 21, and the second conductive via 42 electrically connects the second electrode 12 and the fourth electrode 22. In this embodiment, the first conductive via 41 and the second conductive via 42 extend through the first PTC component 10, the first insulation layer 31, and the second PTC component 20.

In this embodiment, the first conductive via 41 and the second conductive via 42 are disposed to be spaced apart from a periphery of the PTC over-current protection device. Each of the first conductive via 41 and the second conductive via 42 may have a diameter ranging from 0.20 mm to 2.00 mm. In an embodiment, the diameter of each of the first conductive via 41 and the second conductive via 42 is 0.6 mm.

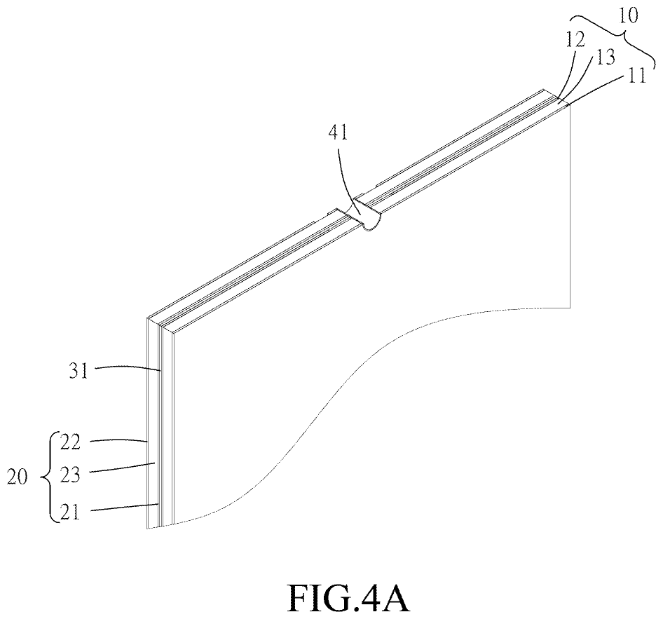

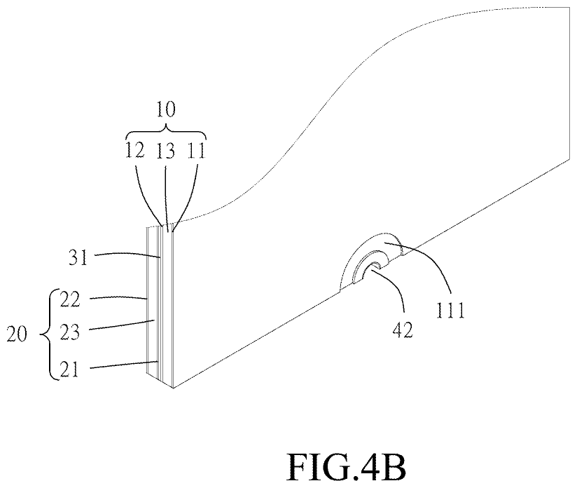

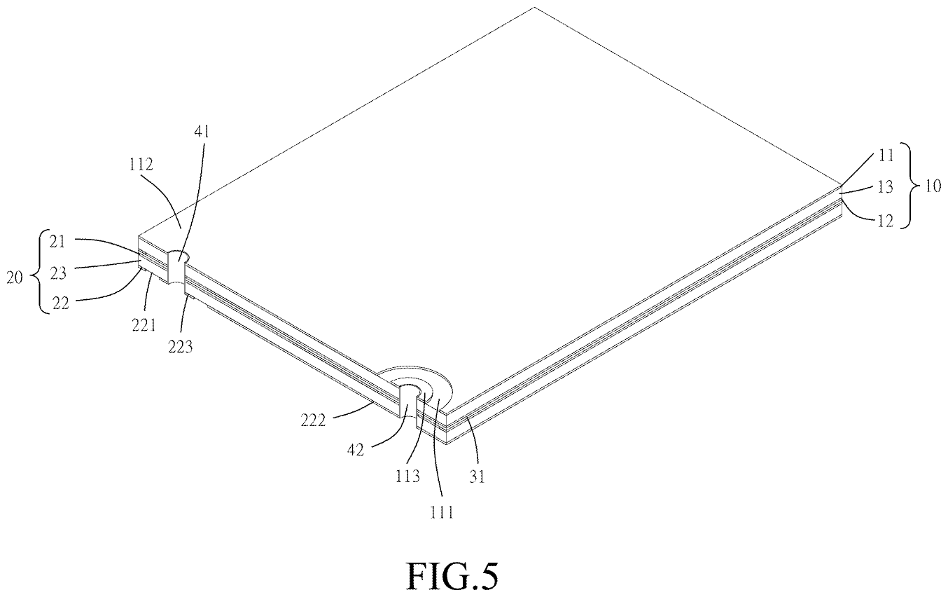

Alternatively, referring to FIGS. 4A and 4B, the first conductive via 41 and the second conductive via 42 may be located at two opposite edges of the PTC over-current protection device. Referring to FIG. 5, the first conductive via 41 and the second conductive via 42 may be located at a same edge of the PTC over-current protection device.

As shown in FIGS. 2 to 5, the first electrode 11 is formed with a first groove 111, the second electrode 12 is formed with a second groove 121, the third electrode 21 is formed with a third groove 211, and the fourth electrode 22 is formed with a fourth groove 221. The first conductive via 41 is electrically isolated from the second electrode 12 and the fourth electrode 22 through the second groove 121 and the fourth groove 221, respectively, and the second conductive via 42 is electrically isolated from the first electrode 11 and the third electrode 21 through the first groove 111 and the third groove 211, respectively.

The first groove 111 extends through the first electrode 11 to divide the first electrode 11 into a conductive portion 112 that is connected to the first conductive via 41, and an isolated portion 113 that is connected to the second conductive via 42 and that is separated from the conductive portion 112 by the first groove 111 so that the second conductive via 42 is separated from the conductive portion 112 of the first electrode 11. In FIG. 2, the first groove 111 is in a ring shape, and the isolated portion 113 surrounds an opening of the second conductive via 42. In FIG. 2, the first groove 111 may have a diameter ranging from 1.50 mm to 4.50 mm, and the isolated portion 113 may have a diameter ranging from 0.50 mm to 3.50 mm. In certain embodiments, the first groove 111 may have a width ranging from 1.50 mm to 4.50 mm, e.g., 1 mm. In FIGS. 4B and 5, the first groove 111 is in a partial-ring shape.

The second groove 121 penetrates through the second electrode 12, and the first conductive via 41 extends through the second groove 121 and is separated from the second electrode 12. The second groove 121 may be a through hole which may have a diameter ranging from 0.50 mm to 3.50 mm. In certain embodiments, the diameter of the second groove 121 is 1.8 mm.

The third groove 211 penetrates through the third electrode 21, and the second conductive via 42 extends through the third groove 211 and is separated from the third electrode 21. The third groove 211 may be a through hole which may have a diameter ranging from 0.50 mm to 3.50 mm. In certain embodiments, the diameter of the third groove 211 is 1.8 mm.

The fourth groove 221 extends through the fourth electrode 22 to divide the fourth electrode 22 into a conductive portion 222 that is connected to the second conductive via 42, and an isolated portion 223 that is connected to the first conductive via 41 and that is separated from the conductive portion 222 by the fourth groove 221 so that the first conductive via 41 is separated from the conductive portion 222 of the fourth electrode 22. Similar to the first groove 111, the fourth groove 221 may be in a ring shape, and the isolated portion 223 surrounds an opening of the first conductive via 41. A diameter and a width of the fourth groove 221 and a diameter of the isolated portion 223 of the fourth electrode 22 fall within the ranges of the first groove 111 and the isolated portion 113 of the first electrode 11.

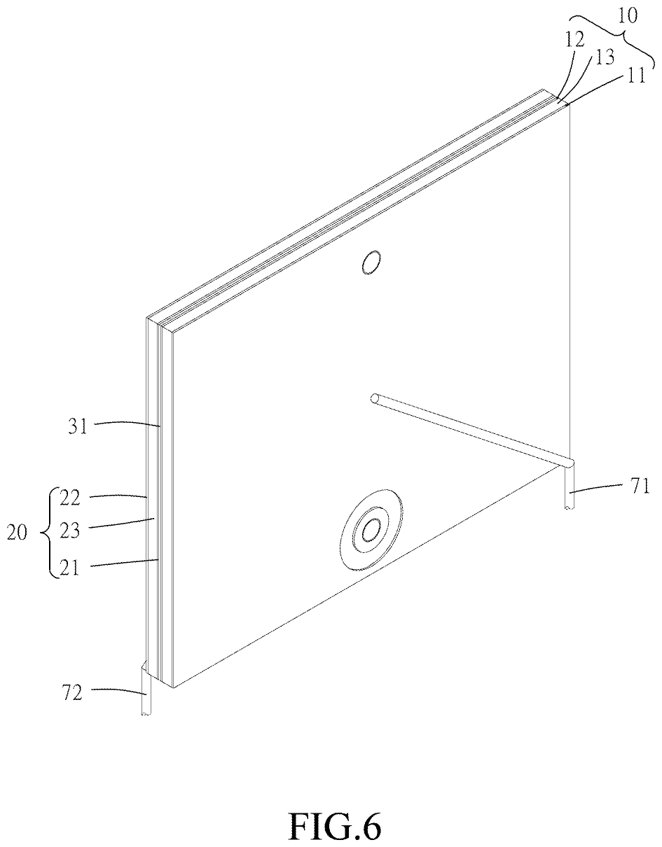

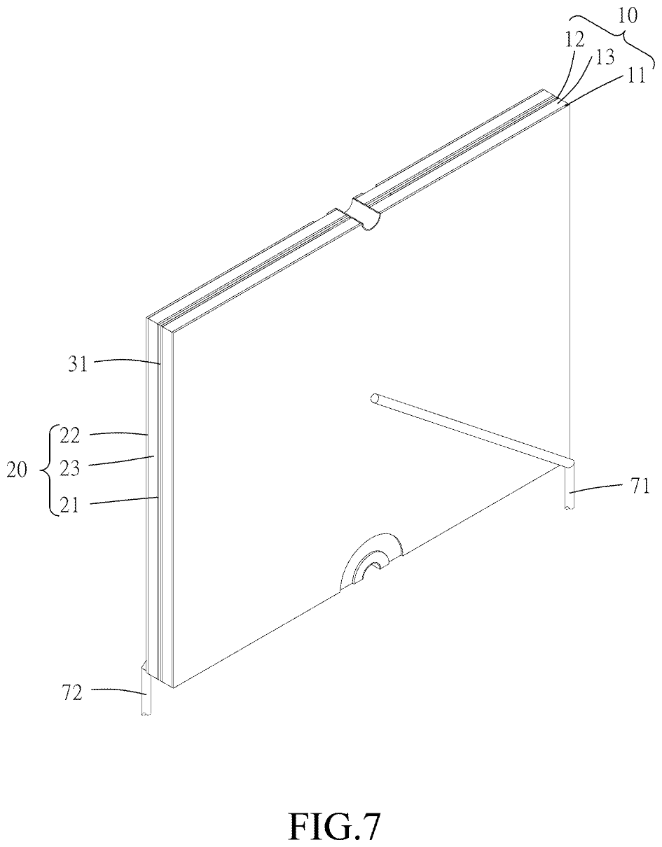

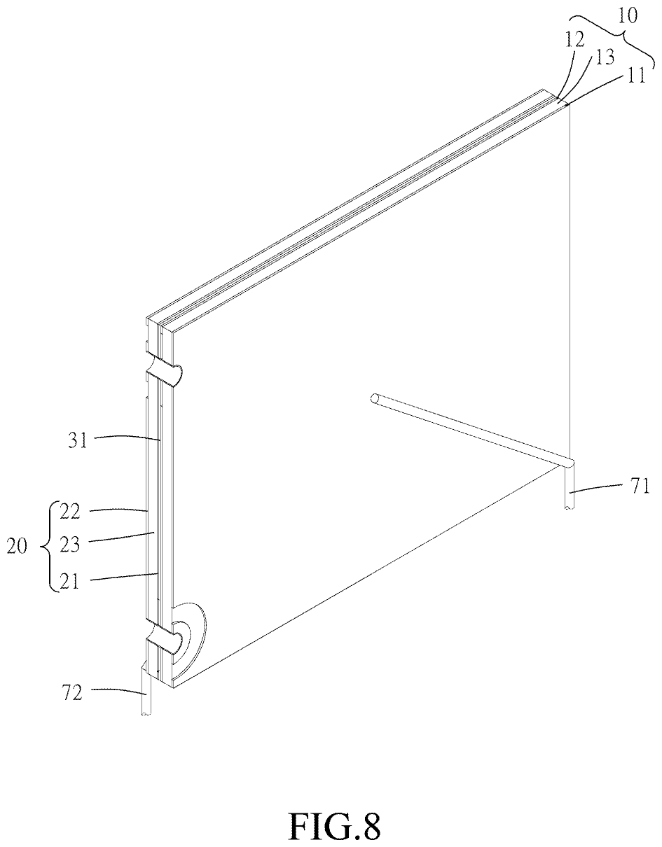

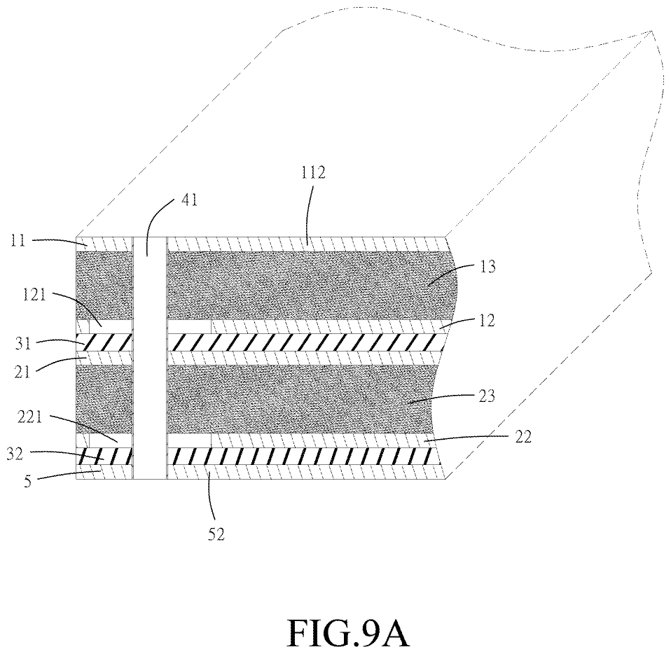

Referring to FIGS. 6 to 8, the PTC over-current protection device may further include a first conductive lead 71 bonded to the first PTC component and a second conductive lead 72 bonded to the second PTC component.

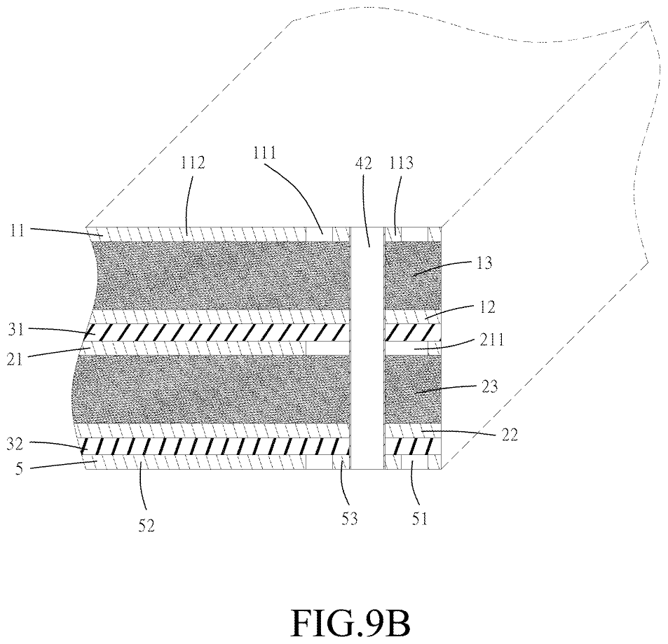

Referring to FIGS. 9A and 9B, another embodiment of the PTC over-current protection device according to the disclosure is generally similar to the embodiment shown in FIGS. 2, 3A, and 3B, except that, in this embodiment, the PTC over-current protection device further includes a second insulation layer 32 disposed on the fourth electrode 22 opposite to the second PTC element 23, and a fifth electrode 5 disposed on the second insulation layer 32 opposite to the fourth electrode 22 and electrically connected to the first conductive via 41. The fifth electrode 5 may be a copper foil sheet such as a nickel-plated copper foil sheet. The first conductive via 41 and the second conductive via 42 extend through the first PTC component 10, the first insulation layer 31, the second PTC component 20, the second insulation layer 32, and the fifth electrode 5. Similar to the previous embodiment where each of the electrodes is formed with a groove, the fifth electrode 5 is formed with a fifth groove 51. The second insulation layer 32 may be made of epoxy glass fiber.

In this embodiment, the first conductive via 41 is electrically isolated from the second electrode 12 and the fourth electrode 22 through the second groove 121 and the fourth groove 221, respectively, and the second conductive via 42 is electrically isolated from the first electrode 11, the third electrode 21, and the fifth electrode 5 through the first groove 111, the third groove 211, and the fifth groove 51, respectively.

In this embodiment, the first groove 111, the second groove 121, and the third groove 211 have shapes the same as those of the previous embodiments. The fourth groove 221 is a through hole, and the first conductive via 41 extends through the fourth groove 221 and is separated from the fourth electrode 22. The fifth groove 51 extends through the fifth electrode 5 to divide the fifth electrode 5 into a conductive portion 52 that is connected to the first conductive via 41, and an isolated portion 53 that is connected to the second conductive via 42 and that is separated from the conductive portion 52 of the fifth electrode 5 by the fifth groove 51 so that the second conductive via 41 is separated from the conductive portion 52 of the fifth electrode 5.

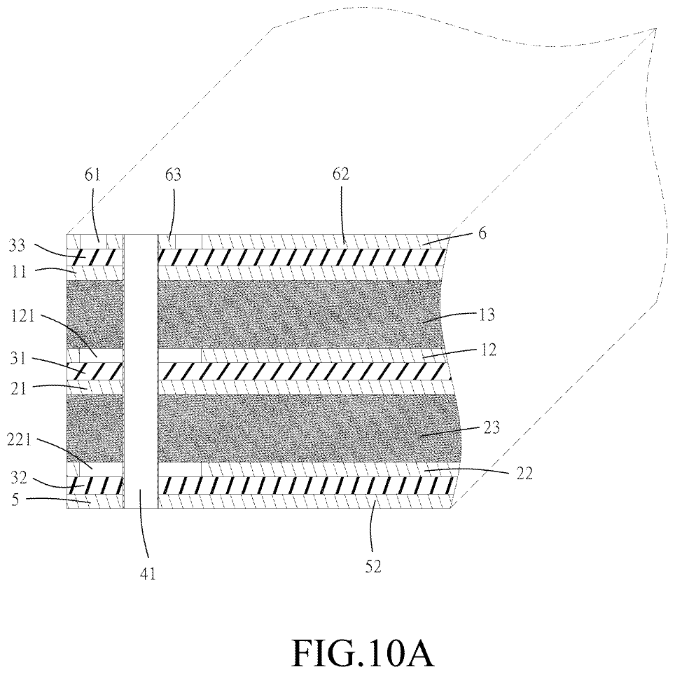

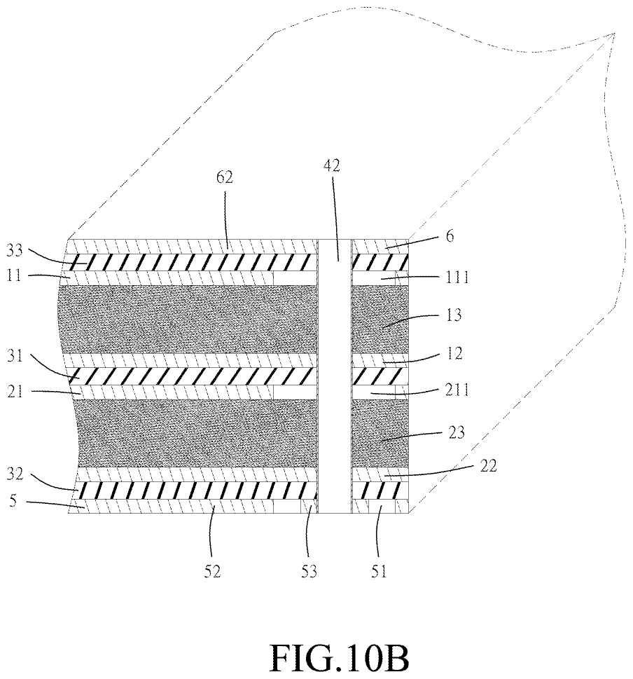

Referring to FIGS. 10A and 10B, a yet another embodiment of the PTC over-current protection device according to the disclosure is generally similar to the embodiment shown in FIGS. 9A and 9B, except that, in this embodiment, the PTC over-current protection device further includes a third insulation layer 33 disposed on the first electrode 11 opposite to the first PTC element 13, and a sixth electrode 6 disposed on the third insulation layer 33 opposite to the first electrode 11 and electrically connected to the second conductive via 42. The sixth electrode 14 may be a copper foil sheet such as a nickel-plated copper foil sheet. The first conductive via 41 and the second conductive via 42 extend through the first PTC component 10, the first insulation layer 31, the second PTC component 20, the second insulation layer 32, the fifth electrode 5, the third insulation layer 33, and the sixth electrode 6. Similar to the previous embodiments where each of the electrodes is formed with a groove, the sixth electrode 6 is formed with a sixth groove 61. Furthermore, the third insulation layer 33 may be made of epoxy glass fiber.

In this embodiment, the first conductive via 41 is electrically isolated from the second electrode 12, the fourth electrode 22, and the sixth electrode 6 through the second groove 121, the fourth groove 221, and the sixth groove 61, respectively, and the second conductive via 42 is electrically isolated from the first electrode 11, the third electrode 21, and the fifth electrode 5 through the first groove 111, the third groove 211, and the fifth groove 51, respectively.

In this embodiment, the second groove 121, the third groove 211, the fourth groove 221, and the fifth groove 51 have shapes the same as those of the previous embodiment. The first groove 111 is a through hole, and the second conductive via 42 extends through the first groove 111 and is separated from the first electrode 11. The sixth groove 61 extends through the sixth electrode 6 to divide the sixth electrode 6 into a conductive portion 62 that is connected to the second conductive via 42, and an isolated portion 63 that is connected to the first conductive via 41 and that is separated from the conductive portion 62 of the sixth electrode 6 by the sixth groove 61 so that the first conductive via 41 is separated from the conductive portion 62 of the sixth electrode 6.

It should be noted that the PTC over-current protection device according to the disclosure may include more than two PTC components based on actual requirements, and two adjacent ones of the PTC components may be sandwiched a corresponding one of the insulation layers.

Examples and comparative examples of the disclosure will be described hereinafter. It is to be understood that these examples and comparative examples are exemplary and explanatory and should not be construed as a limitation to the disclosure.

### Example 1 (E1)

10.25 g of high-density polyethylene (HDPE, serving as non-grafted olefin-based polymer; purchased from Formosa Plastics Corporation; catalog no. HDPE9002), 10.25 g of high density polyethylene grafted with maleic anhydride (serving as a carboxylic anhydride-grafted olefin-based polymer; purchased from DuPont; catalog no. MB100D), and 29.5 g of carbon black (serving as a particulate conductive filler; purchased from Columbian Chemicals Company; catalog no. Raven 430UB) were compounded in a Brabender mixer. The compounding procedure was carried out at 200° C. at a stirring rate of 30 rpm for 10 minutes.

The resultant compounded mixture was hot pressed at 200° C. under 80 kg/cm² for 4 minutes in a mold so as to form a thin sheet of a PTC layer (serving as a PTC element) having a thickness of 0.35 mm.

Two copper foil sheets (serving as electrodes) were attached to two opposite sides of the thin sheet of the PTC layer, and were hot pressed under 200° C. and 80 kg/cm² for four minutes to form a sandwiched structure of a PTC laminate having a thickness of 0.42 mm. The PTC laminate was cut into PTC components, each of which having a size of 13.5 mm×13.5 mm. Each of the PTC components was irradiated with a Cobalt-60 gamma ray for a total irradiation dose of 150 kGy. The PTC components served as the first PTC component 10 and the second PTC component 20.

Thereafter, the second groove 121 (a through hole having a diameter of 1.8 mm) was formed in the second electrode 12 of the first PTC component 10, and the third groove 211 (a through hole having a diameter of 1.8 mm) was formed in the third electrode 21 of the second PTC component 20. Next, the first PTC component 10, an epoxy glass fiberboard (serving as the first insulation layer 31), and the second PTC component 20 were stacked in such order with the second electrode 12 and the third electrode 21 being adjacent to the epoxy glass fiberboard, thereby forming a stacking structure. The stacking structure was hot pressed under 170° C. for one hour.

Next, the stacking structure was drilled with two holes, each having a diameter of 0.65 mm, followed by electroplating, to form the first conductive via 41 and the second conductive via 42 each having a diameter of 0.6 mm. Subsequently, the first groove 111 having a width of 1 mm was formed in the first electrode 11, and the fourth groove 221 having a width of 1 mm was formed in the fourth electrode 22. The PTC over-current protection device (i.e. test sample) of Example 1 was thus formed and has a structure shown in FIG. 2.

### Examples 2 and 3 (E2 and E3)

The processes and conditions for preparing the test samples of Examples 2 and 3 were similar to those of Example 1 except that the first conductive via 41 and the second conductive via 42 in Examples 2 and 3 were located at opposite edges and same edge of the PTC over-current protection device, respectively (see FIGS. 4A/4B and FIGS. 5A/5B, respectively).

### Examples 4-6 (E4-E6)

The processes and conditions for preparing the test samples of Examples 4-6 were similar to those of Examples 1-3 except that each of Examples 4-6 further included the first conductive lead 71 and the second conductive lead 72, each of which having a diameter of 0.8 mm (see FIGS. 6-8 and Table 1).

### Example 7 (E7)

The processes and conditions for preparing the test samples of Example 7 were similar to those of Example 1 except for the following procedures. In Example 7, before stacking, similar to the second groove 121 and the third groove 211, the fourth groove 221 (a through hole having a diameter of 1.8 mm) was formed in the fourth electrode 22. Then, the first PTC component 10, the first insulation layer 31, the second PTC component 20, another epoxy glass fiberboard (serving as the second insulation layer 32) and a copper foil sheet (serving as the fifth electrode 5) were stacked in such order, thereby forming a stacking structure. The stacking structure was hot pressed under 170° C. for one hour. Then, similar to Example 1, the first conductive via 41 and the second conductive via 42 were formed. Subsequently, the first groove 111 having a width of 1 mm was formed in the first electrode 11, and the fifth groove 51 having a width of 1 mm was formed in the fifth electrode 5. Then, the first conductive lead 71 and the second conductive lead 72, each of which having a diameter of 0.8 mm, were connected to the first electrode 11 and fifth electrode 5, respectively. The PTC over-current protection device (i.e., test sample) of Example 7 was thus formed and has a structure shown in FIGS. 9A and 9B (the first conductive lead 71 and the second conductive lead 72 were not shown in these figures).

### Example 8 (E8)

The processes and conditions for preparing the test samples of Example 8 were similar to those of Example 7 except for the following procedures. In Example 8, before stacking, similar to the second groove 121, the third groove 211 and the fourth groove 221, the first groove 111 (a through hole having a diameter of 1.8 mm) was formed in the first electrode 11. Then, a copper foil sheet (serving as the sixth electrode 6), a yet another epoxy glass fiberboard (serving as the third insulation layer 33), the first PTC component 10, the first insulation layer 31, the second PTC component 20, the second insulation layer 32, and the fifth electrode 5 were stacked in such order, thereby forming a stacking structure. The stacking structure was hot pressed under 170° C. for one hour. Then, similar to Example 1, the first conductive via 41 and the second conductive via 42 were formed. Subsequently, the fifth groove 51 having a width of 1 mm was formed in the fifth electrode 5, and the sixth groove 61 having a width of 1 mm was formed in the sixth electrode 6. The PTC over-current protection device (i.e., test sample) of Example 7 was thus formed and has a structure shown in FIGS. 10A and 10B (the first conductive lead 71 and the second conductive lead 72 were not shown in these figures).

### Example 9 (E9)

The processes and conditions for preparing the test samples of Example 9 were similar to those of Example 4 except that except that each of the first conductive lead 71 and the second conductive lead 72 in Example 9 had the diameter of 1.0 mm (see FIG. 6 and Table 1).

### Comparative Example 1 (CE1)

The processes and conditions for preparing the test samples of Comparative Example 1 were as follows.

10.25 g of high-density polyethylene (HDPE, serving as non-grafted olefin-based polymer; purchased from Formosa Plastics Corporation; catalog no. HDPE9002), 10.25 g of high density polyethylene grafted with maleic anhydride (serving as a carboxylic anhydride-grafted olefin-based polymer; purchased from DuPont; catalog no. MB100D), and 29.5 g of carbon black (serving as a particulate conductive filler; purchased from Columbian Chemicals Company; catalog no. Raven 430UB) were compounded in a Brabender mixer. The compounding procedure was carried out at 200° C. at a stirring rate of 30 rpm for 10 minutes.

The resultant compounded mixture was hot pressed at 200° C. under 80 kg/cm² for 4 minutes in a mold so as to form a thin sheet of a PTC layer (serving as a PTC element) having a thickness of 0.35 mm.

Two copper foil sheets (serving as electrodes) were attached to two opposite sides of the thin sheet of the PTC layer, and were hot pressed under 200° C. and 80 kg/cm² for four minutes to form a sandwiched structure of a PTC laminate having a thickness of 0.42 mm. The PTC laminate was cut into PTC components, each of which having a size of 13.5 mm×13.5 mm. Each of the PTC components was irradiated with a Cobalt-60 gamma ray for a total irradiation dose of 150 kGy so as to obtain the PTC over-current protection device of Comparative Example 1 (see Table 1).

### Comparative Example 2 (CE2)

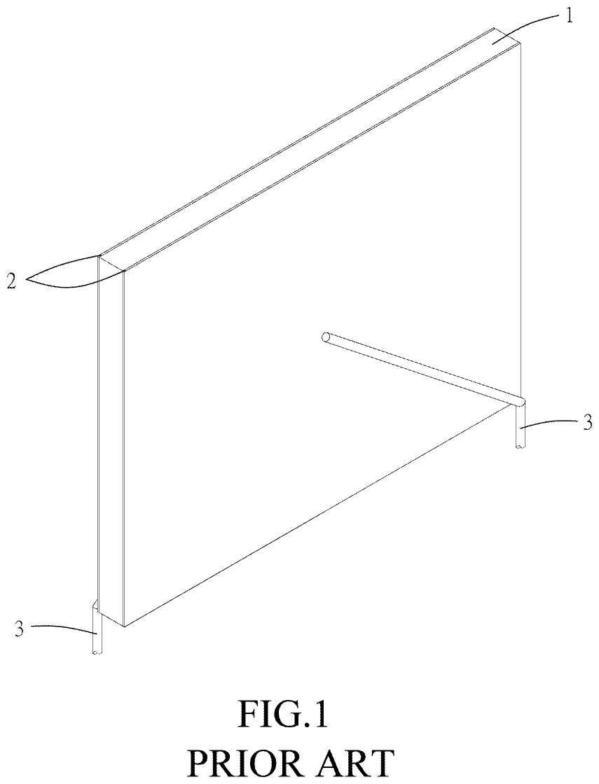

The processes and conditions for preparing the test samples of Comparative Example 2 were similar to as those of Comparative Example 1 except that Comparative Example 2 further included two conductive leads (each having a diameter of 0.8 mm) connected to the two electrodes, respectively (see FIG. 1 and Table 1).

### Comparative Example 3 (CE3)

The processes and conditions for preparing the test samples of Comparative Example 3 were similar to those of Comparative Example 1 except that Comparative Example 1 further included two conductive leads (each having a diameter of 1.0 mm) connected to the two electrodes, respectively (see FIG. 1 and Table 1).

TABLE 1

| | |
|---|---|
| Structure | Diameter |

| | | No. of | of | Resistance |
|---|---|---|---|---|
| | | insulation | conductive | Rᵢ |
| Sample | FIG. | layers | lead (mm) | (milliohm) |
| E 1 | 2 | 1 | No | 1.05 |
| E 2 | 4A and 4B | 1 | No | 1.02 |
| E 3 | 5 | 1 | No | 1.02 |
| E 4 | 6 | 1 | 0.8 | 3.75 |
| E 5 | 7 | 1 | 0.8 | 3.72 |
| E 6 | 8 | 1 | 0.8 | 3.70 |
| E 7 | 9A and 9B | 2 | 0.8 | 3.69 |
| E 8 | 10A and | 3 | 0.8 | 3.68 |
| | 10B | | | |
| E 9 | 6 | 1 | 1.0 | 3.69 |
| CE 1 | 1 | No | No | 4.02 |
| CE 2 | 1 | No | 0.8 | 7.25 |
| CE 3 | 1 | No | 1.0 | 7.23 |

### Resistance Test

Ten test samples of each of E1-E9 and CE1-CE3 were subjected to a resistance test under a voltage of 16 V_{dc} and a current of 100 A using a micro-ohm meter. The average value of the resistances (i.e., initial resistance (Rᵢ)) of the test samples of each of E1-E9 and CE1-CE3 is shown in Table 1.

### Trip Test

Ten test samples of each of E1-E9 and CE1-CE3 were subjected to a trip test under a voltage of 16V_{dc} to determine the trip currents of the test samples. The test sample was deemed to pass the test if the trip time was over 20 seconds (within 20-30 seconds in this test). The average of the trip currents of the passed test samples was obtained and listed in Table 2. The trip currents of E1-E9 range from 27 A to 34 A, which are significantly higher than those of CE1-CE3 (16-20 A), and may protect the circuit when appropriate. The PTC over-current protection device according to the disclosure provides better thermal conductivity and lower resistance than the conventional PTC over-current protection device, so the trip current is higher.

TABLE 2

| | Electrical property | | | | | |
|---|---|---|---|---|---|---|
| | Trip | | 16 V_{dc}/100 A, | | 16 V_{dc}/100 A, | |
| | current | | 6000 cycles test | | 1000 hours test | |
| | Current, | Ratio | R_{f} | R_{f}/Rᵢ | R_{f} | R_{f}/Rᵢ |
| Sample | TA (A) | TA/20 A | milliohm | % | milliohm | % |
| E 1 | 27 | 1.4 | 9.65 | 919% | 6.20 | 590% |
| E 2 | 27 | 1.4 | 9.60 | 941% | 6.04 | 592% |
| E 3 | 27 | 1.4 | 9.57 | 938% | 6.00 | 588% |
| E 4 | 32 | 1.6 | 25.50 | 680% | 15.80 | 421% |
| E 5 | 32 | 1.6 | 25.25 | 679% | 15.65 | 421% |
| E 6 | 32 | 1.6 | 25.04 | 677% | 15.52 | 419% |
| E 7 | 33 | 1.7 | 21.30 | 577% | 13.55 | 367% |
| E 8 | 33 | 1.7 | 20.50 | 557% | 12.65 | 344% |
| E 9 | 34 | 1.7 | 24.85 | 673% | 15.42 | 418% |
| CE 1 | 16 | 0.8 | 71.08 | 1768% | 45.22 | 1125% |
| CE 2 | 20 | 1.0 | 105.42 | 1454% | 66.10 | 912% |
| CE 3 | 20 | 1.0 | 103.40 | 1430% | 65.50 | 906% |

### Switching Cycle Test

Ten test samples of each of E1-E9 and CE1-CE3 were subjected to a switching cycle test to determine variation of the resistances of the test samples. The switching cycle test was conducted under a voltage of 16 V_{dc} and a current of 100 A by switching on for 60 seconds and then off for 60 seconds per cycle for 6000 cycles according to the Underwriter Laboratories UL 1434 Standard for Thermistor-Type Devices. The resistances of each of the test samples before (Rᵢ) and after (R_{f}) the 6000 cycles were measured. A percentage of average resistance variation (R_{f}/Rᵢ×100%) of the test samples of each of E1-E9 and CE1-CE3 was calculated. The results of the switching cycle test are shown in Table 2.

The results in Table 2 show that an average resistance variation of the test samples of each of E1-E9 (i.e., ranging from 457% to 841%) is lower than an average resistance variation of the PTC test samples of each of CE1-CE3 (i.e., ranging from 1330% to 1668%), which indicates that the PTC over-current protection device according to the disclosure that has the stacking structure and the conductive vias exhibits better reliability.

### Aging Test

Ten test samples of each of E1-E9 and CE1-CE3 were subjected to an aging test to determine variation of the resistances of the PTC test samples. The aging test was conducted by applying a voltage of 16 V_{dc} and a current of 100 A to each of the test samples for 1000 hours using a power supply (purchased from IDRC; Model: DSP-060-050), according to the Underwriter Laboratories UL 1434 Standard for Thermistor-Type Devices. The resistances of each of the PTC test samples before (Rᵢ) and after (R_{f}) the 1000 hours were measured. A percentage of average resistance variation (R_{f}/Rᵢ×100%) of the test samples of each of E1-E9 and CE1-CE3 was calculated. The results of the aging test are shown in Table 2.

The results in Table 2 show that an average resistance variation rate of the PTC test samples of each of E1-E9 (i.e., ranging from 244% to 492%) is lower than an average resistance variation rate of the PTC test samples of each of CE1-CE3 (i.e., ranging from 806% to 1025%), which indicates that the PTC over-current protection device according to the disclosure that has the stacking structure and the conductive vias exhibits better reliability.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A positive temperature coefficient (PTC) over-current protection device, comprising:
a first PTC component that includes a first electrode, a second electrode, and a first PTC element sandwiched between said first electrode and said second electrode;
a second PTC component that includes a third electrode, a fourth electrode, and a second PTC element sandwiched between said third electrode and said fourth electrode;
a first insulation layer that is disposed between said first PTC component and said second PTC component;
a first conductive via that electrically connects said first electrode and said third electrode; and
a second conductive via that electrically connects said second electrode and said fourth electrode.

2. The PTC over-current protection device as claimed in claim 1, wherein said second electrode and said third electrode are disposed adjacent to said first insulation layer relative to said first electrode and said fourth electrode.

3. The PTC over-current protection device as claimed in claim 1, wherein said first conductive via and said second conductive via extend through said first PTC component, said first insulation layer, and said second PTC component.

4. The PTC over-current protection device as claimed in claim 1, wherein said first electrode is formed with a first groove, said second electrode is formed with a second groove, said third electrode is formed with a third groove, and said fourth electrode is formed with a fourth groove, said first conductive via is electrically isolated from said second electrode and said fourth electrode through said second groove and said fourth groove, respectively, and said second conductive via is electrically isolated from said first electrode and said third electrode through said first groove and said third groove, respectively.

5. The PTC over-current protection device as claimed in claim 4, wherein said first groove extends through said first electrode to divide said first electrode into a conductive portion that is connected to said first conductive via, and an isolated portion that is connected to said second conductive via and that is separated from said conductive portion by said first groove so that said second conductive via is separated from said conductive portion of said first electrode.

6. The PTC over-current protection device as claimed in claim 5, wherein said first groove is in a ring shape, said isolated portion surrounding an opening of said second conductive via.

7. The PTC over-current protection device as claimed in claim 4, wherein said second groove penetrates through said second electrode, said first conductive via extending through said second groove and being separated from said second electrode.

8. The PTC over-current protection device as claimed in claim 4, wherein said third groove penetrates through said third electrode, said second conductive via extending through said third groove and being separated from said third electrode.

9. The PTC over-current protection device as claimed in claim 4, wherein said fourth groove extends through said fourth electrode to divide said fourth electrode into a conductive portion that is connected to said second conductive via, and an isolated portion that is connected to said first conductive via and that is separated from said conductive portion by said fourth groove so that said first conductive via is separated from said conductive portion of said fourth electrode.

10. The PTC over-current protection device as claimed in claim 1, further comprising a first conductive lead bonded to said first PTC component and a second conductive lead bonded to said second PTC component.

11. The PTC over-current protection device as claimed in claim 1, wherein said first conductive via and said second conductive via are located at opposite edges of said PTC over-current protection device.

12. The PTC over-current protection device as claimed in claim 1, wherein said first conductive via and said second conductive via are located at a same edge of said PTC over-current protection device.

13. The PTC over-current protection device as claimed in claim 1, further comprising a second insulation layer disposed on said fourth electrode, and a fifth electrode disposed on said second insulation layer opposite to said fourth electrode and electrically connected to said first conductive via.

14. The PTC over-current protection device as claimed in claim 13, wherein said first conductive via and said second conductive via extend through said first PTC component, said first insulation layer, said second PTC component, said second insulation layer, and said fifth electrode.

15. The PTC over-current protection device as claimed in claim 13, wherein said first electrode is formed with a first groove, said second electrode is formed with a second groove, said third electrode is formed with a third groove, said fourth electrode is formed with a fourth groove, and said fifth electrode is formed with a fifth groove, said first conductive via is electrically isolated from said second electrode and said fourth electrode through said second groove and said fourth groove, respectively, and said second conductive via is electrically isolated from said first electrode, said third electrode, and said fifth electrode through said first groove, said third groove, and said fifth groove, respectively.

16. The PTC over-current protection device as claimed in claim 13, wherein said first groove extends through said first electrode to divide said first electrode into a conductive portion that is connected to said first conductive via, and an isolated portion that is connected to said second conductive via and that is separated from said conductive portion by said first groove so that said second conductive via is separated from said conductive portion of said first electrode, and said fifth groove extends through said fifth electrode to divide said fifth electrode into a conductive portion that is connected to said first conductive via, and an isolated portion that is connected to said second conductive via and that is separated from said conductive portion of said fifth electrode by said fifth groove so that said second conductive via is separated from said conductive portion of said fifth electrode.

17. The PTC over-current protection device as claimed in claim 13, further comprising a third insulation layer disposed on said first electrode, and a sixth electrode disposed on said third insulation layer opposite to said first electrode and electrically connected to said second conductive via.

18. The PTC over-current protection device as claimed in claim 17, wherein said first conductive via and said second conductive via extend through said first PTC component, said first insulation layer, said second PTC component, said second insulation layer, said fifth electrode, said third insulation layer, and said sixth electrode.

19. The PTC over-current protection device as claimed in claim 17, wherein said first electrode is formed with a first groove, said second electrode is formed with a second groove, said third electrode is formed with a third groove, said fourth electrode is formed with a fourth groove, said fifth electrode is formed with a fifth groove, and said sixth electrode is formed with a sixth groove, said first conductive via is electrically isolated from said second electrode, said fourth electrode, and said sixth electrode through said second groove, said fourth groove, and said sixth groove, respectively, and said second conductive via is electrically isolated from said first electrode, said third electrode, and said fifth electrode through said first groove, said third groove, and said fifth groove, respectively.

20. The PTC over-current protection device as claimed in claim 13, wherein each of said first insulation layer, said second insulation layer, said third insulation layer is made of epoxy glass fiber.
